(19) United States
(12) Patent Application Publication
(10) Pub. No.: US 2018/0017803 A1
(43) Pub. Date: Jan. 18, 2018

(54) ACCESSORY AND LENS SYSTEM

(71) Applicant: HTC Corporation, Taoyuan City (TW)

(72) Inventors: Jen-Yang Chang, Taoyuan City (TW); Chang-Hua Wei, Taoyuan City (TW); Wei-Hsin Chang, Taoyuan City (TW)

(21) Appl. No.: 15/213,348

(22) Filed: Jul. 18, 2016

(51) Int. Cl. G02B 27/22; G02B 7/02

(52) U.S. Cl. CPC G02B 27/2257; G02B 7/021; G02B 27/2242

(57) ABSTRACT

An accessory includes a lens frame and a pair of lenses. The lens frame includes a spacer plate, a lens plate and a pair of foldable plates. The spacer plate is coupled to a portable device. The lens plate is flexibly connected to the spacer plate. The pair of foldable plates are flexibly connected between the spacer plate and the lens plate. The pair of foldable plates are unfolded in using state so the lens plate is opened in a preset angle relative to the spacer plate. The pair of foldable plates are folded in folding state so the spacer plate and the lens plate overlap each other. The pair of lenses are disposed on the lens plate, and positioned in front of a display of the portable device in using state. A lens system including aforesaid portable device, the lens frame and the pair of lenses is also provided.

### BACKGROUND

### Field of the Invention

The present application relates to an accessory, which is adapted to a portable device (e.g., a smart phone) for providing a pair of lenses in front of a display of the portable device in a using state.

### Related Art

Currently, the virtual reality technology has been increasingly applied to consumer electronics products such as a virtual reality display and a virtual reality glasses. The virtual reality display is provided with a display module and special lenses of its own for presenting virtual reality images. The virtual reality glass, which includes only the special lenses, needs to work together with a portable device having a display (e.g., a smart phone). User eyes can experience a three-dimensional visual effect by viewing the virtual reality images displayed by the display of the portable device through a pair of lenses of the virtual reality glasses. The virtual reality glasses today usually adopt a headset design which is advantageous for users in terms of hands-free and wearing over long period of time. Nonetheless, the virtual reality glasses adopted the headset design is usually large in size, which is disadvantageous for users to carry around.

### SUMMARY

The present application provides an accessory, adapted to be mounted on a portable device (e.g., a smart phone) to provide a pair of lens for virtual reality in front of a display of the portable device.

The present application provides a lens system, adapted to generate virtual reality images for users to view them through the eyes.

The accessory of the present application is adapted to be connected to a portable device having a display. The accessory includes a lens frame and a pair of lenses. The lens frame includes a spacer plate, a lens plate and a pair of foldable plates. The spacer plate is coupled to a portable device. The lens plate is flexibly connected to the spacer plate. One of the pair of foldable plates is flexibly connected between one end of the space plate and one corresponding end of the lens plate. Another of the pair of foldable plates is flexibly connected between another end of the space plate and another corresponding end of the lens plate. The pair of foldable plates are unfolded in a using state so the lens plate is opened in a preset angle relative to the spacer plate. The pair of foldable plates are folded in a folding state so the spacer plate and the lens plate overlap each other. The pair of lenses are disposed on the lens plate, and positioned in front of a display of the portable device in the using state.

The lens system of the present application includes aforesaid portable device, aforesaid lens frame and aforesaid pair of lenses.

Based on the above, in the present application, the pair of lenses of the accessory or the lens system can be positioned in front of the display of the portable device so the user eyes are able to view the virtual reality images displayed by the display through the pair of lenses. In addition, the lens frame of the accessory or the lens system may also be folded on the portable device, which is advantageous for users to carry around.

To make the above features and advantages of the present application more comprehensible, several embodiments accompanied with drawings are described in detail as follows.

### BRIEF DESCRIPTION OF THE DRAWINGS

FIG. 1A is a three dimensional view of an accessory connected to a portable device in a using state according to an embodiment of the present application.

FIG. 1B is a three dimensional view of the accessory of FIG. 1A mounted on the portable device in a transition state.

FIG. 1C is a three dimensional view of the accessory of FIG. 1A mounted on the portable device in a folding state.

FIG. 2 is a plane view of the accessory of FIG. 1C in an unfolding state.

FIG. 3A is a three dimensional view of the accessory of FIG. 1C detached from the portable device in a specific angle.

FIG. 3B is a three dimensional view of the accessory of FIG. 1C detached from the portable device in another specific angle.

### DESCRIPTION OF EMBODIMENTS

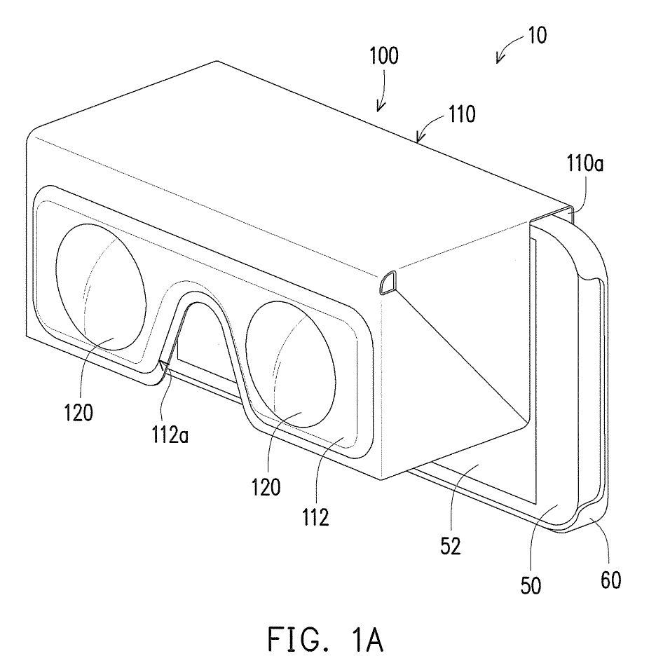

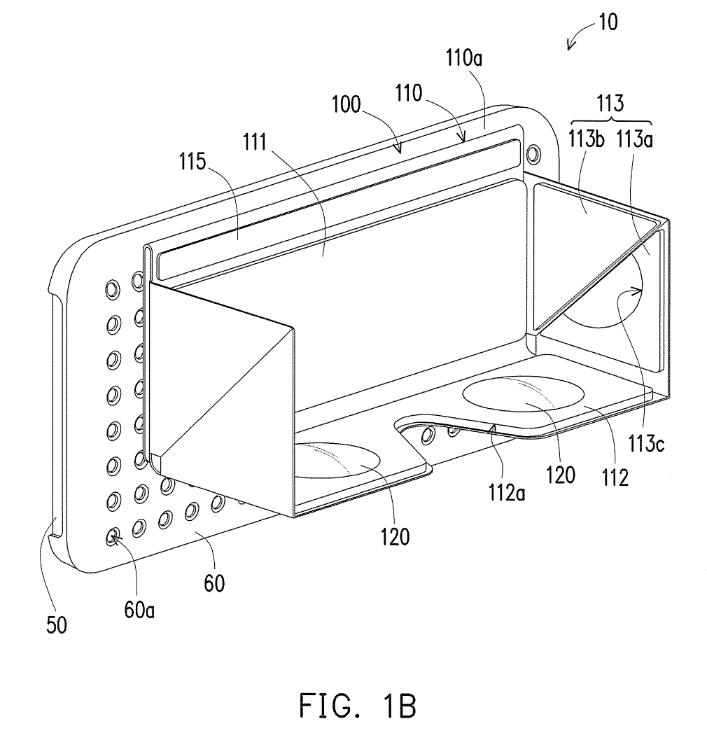

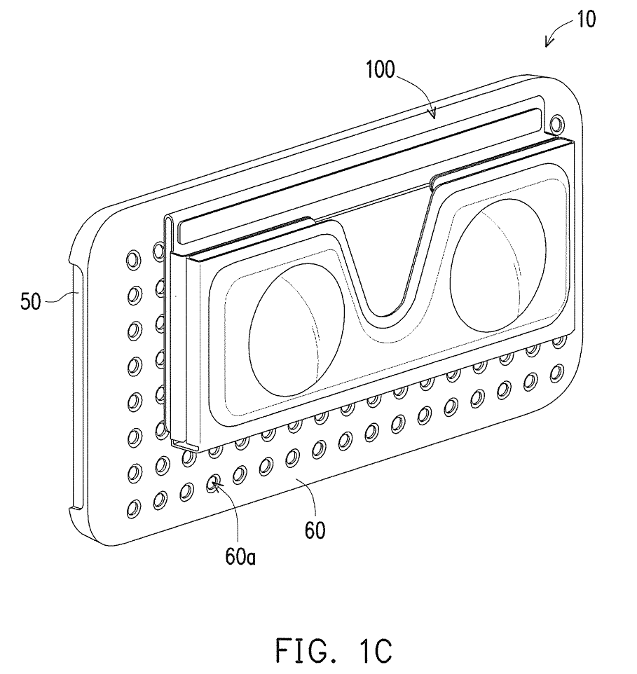

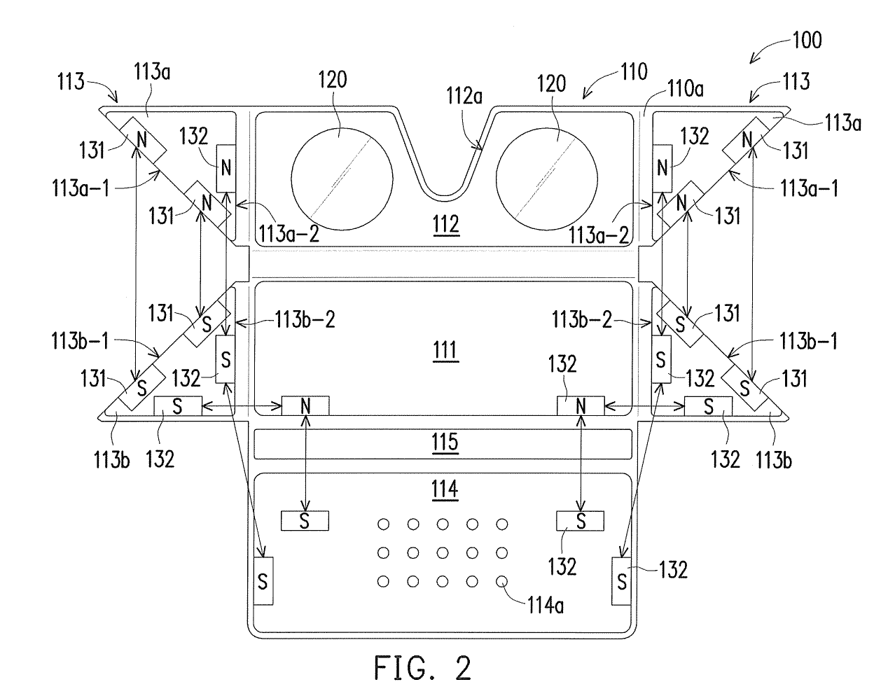

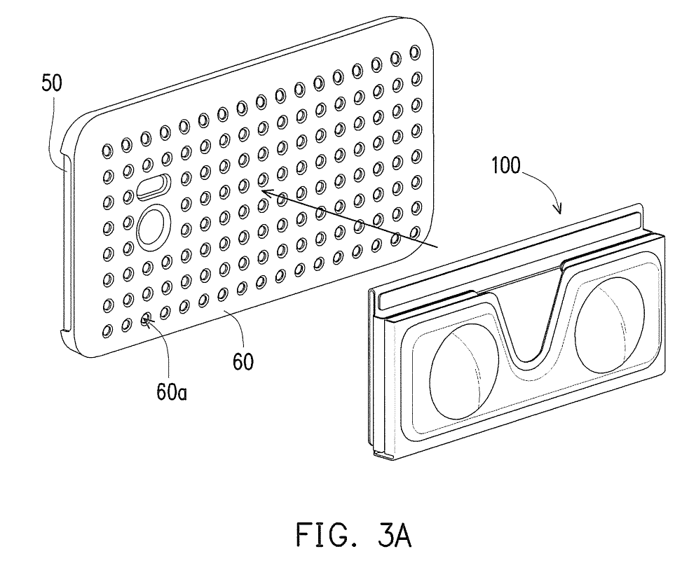

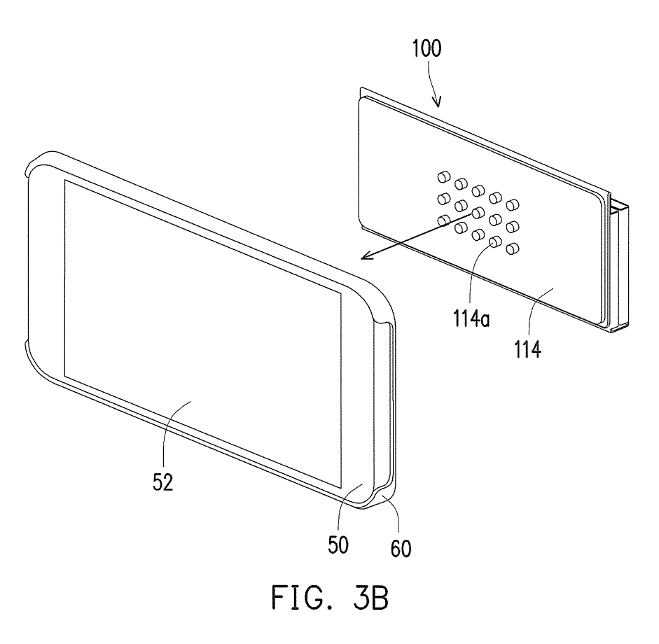

Referring to FIG. 1A and FIG. 2, in the present embodiment, an accessory 100 is adapted to be connected to a portable device 50 (e.g., a smart phone) having a display 52 (as shown in FIG. 3). Users can experience a three-dimensional visual effect by viewing virtual reality images displayed by the display 52 of the portable device 100. The accessory 100 includes a lens frame 110 and a pair of lenses 120. The pair of lenses 120 are, for example, convex lenses and disposed on the lens frame 110. Specifically, the lens frame 110 includes a spacer plate 111, a lens plate 112 and a pair of foldable plates 113. The spacer plate 111 is coupled to the portable device 50. The lens plate 112 is flexibly connected to the spacer plate 111. One of the pair of foldable plates 113 is flexibly connected between one end of the space plate 111 and one corresponding end of the lens plate 112, and another of the pair of foldable plates 113 is flexibly connected between another end of the space plate 111 and another corresponding end of the lens plate 112. The pair of lenses 120 are disposed on the lens plate 112, and positioned in front of the display 52 of the portable device 50 in a using state. In the present embodiment, the lens frame 110 may include a soft skin 110a so aforementioned members included by the lens frame 110 can be flexibly connected to one another through the soft skin 110a. Further, the lens plate 112 may have a notch 112a, which is between the pair of lenses 120 and adapted to accommodate a user's nose bridge.

Referring to FIG. 1A, in the present embodiment, the pair of foldable plates 113 are unfolded in the using state so the lens plate 112 is opened in a preset angle relative to the spacer plate 111, so the pair of lenses 120 disposed on the lens plate 112 can be positioned in front of the display 52 of the portable device 50 in the using state. When not in use, the user may flip the lens frame 110 to the rear side of the portable device 50 (as shown in FIG. 1B). Next, as shown in FIG. 1B, the pair of foldable plates 113 may be manually folded to move the lens plate 112 and the spacer plate 111 close to each other. Lastly, as shown in FIG. 1C, the pair of foldable plates 113 are folded in a folding state so the spacer plate 111 and the lens plate 112 overlap each other. In the present embodiment, the pair of foldable plates 113 are folded between the spacer plate 111 and the lens plate 112 in the folding state.

Referring to FIG. 1B and FIG. 2, in the present embodiment, each of the foldable plates 113 includes a first triangular portion 113a and a second triangular portion 113b, the first triangular portion 113a has a first folding edge 113a-1 and a first connecting edge 113a-2, the second triangular portion 113b has a second folding edge 113b-1 and a second connecting edge 113b-2, the first folding edge 113a-1 of each of the first triangular portions 113a and the second folding edge 113b-1 of the corresponding second triangular portion 113b are connected to each other, the first connecting edge 113a-2 of each of the first triangular portions 113a is flexibly connected to the spacer plate 111, and the second connecting edge 113b-2 of each of the second triangular portions 113b is flexibly connected to the lens plate 112 separately. In the present embodiment, the first folding edge 113a-1 of each of the first triangular portions 113a and the second folding edge 113b-1 of the corresponding second triangular portion 113b are connected to each other due to magnetic attraction.

Referring to FIG. 1B and FIG. 2, in the present embodiment, the accessory 100 may further include at least two pairs of folded magnetic members 131 (e.g., a plurality of permanent magnets). Each pair of folded magnetic members 131 is separately disposed between the first folding edge 113a-1 of the corresponding first triangular portion 113a and the second folding edge 113b-1 of the corresponding second triangular portion 113b so a magnetic force from the pairs of folded magnetic members 131 is able to maintain the foldable plates 113 unfolded in the using state. In the present embodiment, the two pairs of folded magnetic members 131 are adopted to provide the magnetic force between each first folding edge 113a-1 and the corresponding second folding edge 113b-1.

Referring to FIG. 1B, in the present embodiment, each of the foldable plates 113 has a concave surface 113c caved to the corresponding first triangular portion 113a, and the concave surface 113c approximately matches a shape of the corresponding lens 120. Therefore, in the folding state, the first triangular portion 113a of the foldable plate 113 may be prevented from structural mutual interference with the corresponding lens 120 through the concave 113c, and thus the wearing of the lenses 120 may also be prevented.

Referring to FIG. 1B and FIG. 2, in the present embodiment, the accessory 100 may further include a plurality of overlapping magnetic members 132 (e.g., a plurality of permanent magnets). They are embedded in part or all of a group composed of the spacer plate 111, the lens plate 112 and the foldable plates 113 so a magnetic force from at least part of the overlapping magnetic members 132 is able to maintain the spacer plate 111 and the lens plate 112 overlapping each other in the folding state and the magnetic force of the at least part of the overlapping magnetic members 132 is able to maintain the foldable plates 113 unfolded in the using state. Referring to FIG. 2, double arrows indicate the situation where these overlapping magnetic members 132 are attached to each other in pairs in the folding state.

Referring to FIG. 1A and FIG. 2, in the present embodiment, the lens frame 110 further includes a cross over plate 115, which is flexibly connected to the spacer plate 111 and coupled to the portable device 50 to cross over a side edge of the portable device 50.

Referring to FIG. 2, FIG. 3A and FIG. 3B, in the present embodiment, the lens frame 110 further includes a mounting plate 114. The mounting plate 114 is flexibly connected to the spacer plate 111 and adapted to be assembled to a protective case 60. Further, in the present embodiment, the mounting plate 114 has a plurality of accessory fitting portions 114a (e.g., a plurality of fitting pillars) adapted to be coupled to a plurality of device fitting portions 60a (e.g., a plurality of fitting holes) of the protective case 60. In the present embodiment, the protective case 60 refers to a protective shell which allows the portable device 50 to be disposed in the protective case 60. In another embodiment not illustrated, the mounting plate 114 is flexibly connected to the spacer plate 111, and adapted to be directly assembled to an original housing of the portable device 50. In another embodiment not illustrated, the accessory 100 further includes a protective case (similar to the protective case 60 of FIG. 1A), which is flexibly connected to the spacer plate 111, and adapted to be mounted on the portable device 50. In this case, the mounting plate 114 of FIG. 1A may be omitted.

Referring to FIG. 1A, FIG. 1B and FIG. 1C, the portable device 50, the lens frame 110 and the pair of lenses 120 can constitute a lens system 10, which may also include other members. The lens system 10 can generate virtual reality images through the display 52 of the portable device 50 and allows user eyes to view the virtual reality images through the pair of lenses 120. Moreover, in the present embodiment, the lens system 10 may further include the protective case 60. The portable device 50 is disposed in the protective case 60. The spacer plate 111 is flexibly connected to one side of the protective case 60. The spacer plate 111 is coupled to the portable device 50 via the protective case 60.

In summary, in the present application, the pair of lenses of the accessory or the lens system can be positioned in front of the display of the portable device so the user eyes are able to view the virtual reality images displayed by the display through the pair of lenses. In addition, the lens frame of the accessory or the lens system may also be folded on the portable device, which is advantageous for users to carry around.

It will be apparent to those skilled in the art that various modifications and variations can be made to the structure of the present application without departing from the scope or spirit of the present application. In view of the foregoing, it is intended that the present application cover modifications and variations of this application provided they fall within the scope of the following claims and their equivalents.

1. An accessory, adapted to be connected to a portable device having a display, comprising:
a lens frame, comprising:
a spacer plate, coupled to the portable device;
a lens plate, flexibly connected to the spacer plate; and
a pair of foldable plates, one of the pair of foldable plates being foldably fixed between one end of the space plate and one corresponding end of the lens plate, another of the pair of foldable plates being flexibly connected between another end of the space plate and another corresponding end of the lens plate, wherein the pair of foldable plates are unfolded in a using state so the lens plate is opened in a preset angle relative to the spacer plate, and the pair of foldable plates are folded in a folding state so the spacer plate and the lens plate overlap each other; and
a pair of lenses, disposed on the lens plate, and positioned in front of the display of the portable device in the using state.

2. The accessory according to claim 1, wherein the lens plate has a notch between the pair of lenses which is adapted to accommodate a user's nose bridge.

3. The accessory according to claim 1, wherein the pair of foldable plates are folded between the spacer plate and the lens plate in the folding state.

4. The accessory according to claim 1, wherein each of the foldable plates comprises a first triangular portion and a second triangular portion, the first triangular portion has a first folding edge and a first connecting edge, the second triangular portion has a second folding edge and a second connecting edge, the first folding edge of each of the first triangular portions and the second folding edge of the corresponding second triangular portion are connected to each other, the first connecting edge of each of the first triangular portions is flexibly connected to the spacer plate, and the second connecting edge of each of the second triangular portions is flexibly connected to the lens plate separately.

5. The accessory according to claim 4, further comprising:
two pairs of magnetic members, each pair of magnetic members being separately disposed between the first folding edge of the corresponding first triangular portion and the second folding edge of the corresponding second triangular portion so a magnetic force from the pairs of magnetic members is able to maintain the foldable plates unfolded in the using state.

6. The accessory according to claim 1, further comprising:
a plurality of overlapping magnetic members, embedded in part or all of a group composed of the spacer plate, the lens plate and the foldable plates so a magnetic force from at least part of the overlapping magnetic members is able to maintain the spacer plate and the lens plate overlapping each other in the folding state and the magnetic force of the at least part of the overlapping magnetic members is able to maintain the foldable plates unfolded in the using state.

7. The accessory according to claim 1, wherein the lens frame further comprises:
a cross over plate, flexibly connected to the spacer plate and adapted to be coupled to the portable device to cross over a side edge of the portable device.

8. The accessory according to claim 1, wherein the lens frame further comprises:
a mounting plate, flexibly connected to the spacer plate and adapted to be assembled to a rear case of the portable device.

9. The accessory according to claim 8, wherein the mounting plate has a plurality of accessory fitting portions adapted to be coupled to a plurality of device fitting portions mounted on a rear case of the portable device respectively.

10. The accessory according to claim 1, further comprising:
a protective case, flexibly connected to the spacer plate and adapted to be mounted on the portable device.

11. A lens system, comprising:
a portable device having a display;
a lens frame, comprising:
a spacer plate, coupled to the portable device;
a lens plate, flexibly connected to the spacer plate; and
a pair of foldable plates, one of the pair of foldable plates being foldably fixed between one end of the space plate and one corresponding end of the lens plate, another of the pair of foldable plates being flexibly connected between another end of the space plate and another corresponding end of the lens plate, wherein the pair of foldable plates are unfolded in a using state so the lens plate is opened in a preset angle relative to the spacer plate, and the pair of foldable plates are folded in a folding state so the spacer plate and the lens plate overlap each other; and
a pair of lenses, disposed on the lens plate, and positioned in front of the display of the portable device in the using state.

12. The lens system according to claim 11, further comprising:
a protective case, the portable device being disposed in the protective case, the spacer plate being flexibly connected to one side of the protective case, the spacer plate being coupled to the portable device via the protective case.
